(19) United States
(12) Patent Application Publication
(10) Pub. No.: US 2018/0044441 A1
(43) Pub. Date: Feb. 15, 2018

(54) Chondroitin sulfate preparation process and equipment thereof

(71) Applicant: Muliang ZHANG, Heze, Shandong (CN)

(72) Inventor: Muliang ZHANG, Heze, Shandong (CN)

(21) Appl. No.: 15/534,459

(22) PCT Filed: Feb. 4, 2015
(86) PCT No.: PCT/CN2015/000078

§ 371 Date: Aug. 30, 2017

(30) Foreign Application Priority Data
Aug. 12, 2014 (CN) 201410738968.4

(51) Int. Cl. C08B 37/00

(52) U.S. Cl. CPC C08B 37/0069

(57) ABSTRACT

A chondroitin sulfate preparation process and device thereof and in particular a process for extracting ten thousand tons of chondroitin sulfate by means of a solvent-free process is disclosed. The process comprises steps such as liquefaction, extraction, enzymolysis and degradation, filtering, separation and after-treatment. The device comprises a reaction kettle. The reaction kettle is preferably a Teflon reaction kettle. The reaction kettle is in pipeline connection with a vacuum circulation filter, a filtrate storage tank and a molecular sieve in sequence. The molecular sieve is separately in pipeline connection with a protein fluid storage tank and a CS solution storage tank. The present invention has the advantages of low investment. Compared to the same production scale, the investment is cut by 80%. The larger the production scale is the more advantageous in investment. The production capacity is over million tons, which is unattainable by solvent-process technology. The production is automatic and continuous. The production quality is controllable. The CPC content is 60%-105% and other quality indexes meets or exceeds the current quality standard. The production is no pollution, zero discharge and environmentally friendly.

### CROSS REFERENCE OF RELATED APPLICATION

This is a U.S. National Stage under 35 U.S.C 371 of the International Application PCT/CN2015/000078, filed Feb. 4, 2015, which claims priority under 35 U.S.C. 119(a-d) to CN 201410738968.4, filed Dec. 8, 2014.

### BACKGROUND OF THE PRESENT INVENTION

### Field of Invention

The present invention relates to a chondroitin sulfate preparation method, and more particularly to a solvent-free ten thousand tons chondroitin sulfate extraction method and the device thereof, which is in the chondroitin sulfate extraction field.

### Description of Related Arts

Chondroitin sulfate (CS) was first extracted from the animal cartilage in 1861 by Americans. Until now the key technology in the extraction and purification process is using organic solvent because the chondroitin sulfate is soluble in water and insoluble in organic solvent. The ordinary solvents comprise acetone, ethanol, ether and chloroform, wherein the acetone, ether and chloroform are toxic and have side-effect which are discarded. Until now the techniques adopted by CS extraction and purification process are determined by the solvent concentration worldwide. The producers of CS normally adopt ethanol for CS extraction and purification instead of acetone due to the acetone has low boiling point and is highly volatile which is dangerous. The CS producers normally adopt ethanol for extraction and purification. The conventional CS extraction methods and techniques comprise: (1) dilute base extraction method (Biochemical Technology); (2) concentrated base extraction method (Biochemical products preparation technology, college textbook in 21^{st} century bio-engineering series, by Chen Laitong, fifth print in January 2012); (3) dilute base-concentrated salt solution extraction method; (4) enzymolysis-resin extraction method.

The conventional preparation methods have the disadvantages as follow: (1) to establish a new CS extraction and purification manufactory adopting solvent preparation methods requires huge investment in fixed assets, low efficiency in funds usage, long construction cycle for new factories, unobvious benefits, which cause high product cost and difficulties in expending the consumer market; taking a CS manufacture with a producing capacity of million tons for example, which produces all the materials, requires an area not less than 6000 square meters; the investment is over five million RMB which covers the device and construction work required by the solvent recover system, heating system, cooling system and sewage system and necessary cost for fulfilling GMP (Good Manufacturing Practice) requirements on fire security, explosion proof, lightning proof and production workshop (finishing, drying or packaging workshop); the investment doesn't include the cost of office area and living quarters, besides the Environmental Impact Assessment is difficult to pass; the construction cycle is over 8 months; (2) Due to the solvent method for CS preparation cost long hours for extraction and purification, which cause low product outcome and high unit cost; to finish the whole solvent preparation process need at least 50 hours from materials input to finishing, drying and packaging working section; (3) The price of the solvent is high, which accounts for a big proportion in the fringe cost; the solvent needs to be recovered and reused, the working section of which is a bottle neck of the production process; the recovery of the solvent needs to be carried out outdoors and requires a flame-proof and explosion-proof environment, which is separated from other working sections; until now a CS automatic or semi-automatic production line is not able to be designed for use worldwide; (4) High energy consumption in the CS extraction and purification process adopts solvent method refers to the consumption of coal, electricity, water and solvent and workers' salary in the solvent recovery working section; the high energy consumption causes an increase in the product cost by over 10000 RMB per ton and has potential safety hazard; (5) High pollution in the solvent method refers to the huge consumption of the sodium hydroxide (lye) and the hydrochloric acid; to produce 1000 kg CS products with fresh beef brisket needs 20 tons of the materials and 20 tons of purified water if the yield is 5%, which generates 40 tons of liquid; If adopts the dilute base-concentrated salt solution method, over 800 kg sodium hydroxide, over 1850 kg hydrochloric acid and over 1000 kg sodium chloride are needed; the solvent consumption is around 1500 kg; Waste water generated in the solvent recovery section is over 60 tons (COD (Chemical oxygen demand) is over 80000 units), plus the materials washing water and sanitary flushing water, the total amount of waste liquid and waste water for producing one ton of CS product is over hundred tons (besides the air pollution and domestic sewage); The sewage-treatment equipments are required, otherwise the factory is not able to fulfill the requirements of Environmental Impact Assessment and go into operation; (6) the yield of the solvent method is low, which is caused by the technical defects; during extraction and purification, the single enzyme is not able to work as endonuclease and exonucleases, which causes unthorough enzymolysis and degradation, liquid not separating to layers, protein not clustering or insufficient degradation; the filtration becomes difficult and the product yield and quality is affected (the yield refers to the weight of the CS product extracted from per hundred kilogram of dry or fresh materials collected from same part of the animal cartilage); (7) The CS content in the product extracted and purified by the solvent method is rather low; in large scale production, the CS product content is normally less than 95% (refers to CPC (cephalosporin C) content); A certain amount of protein, solvent and hydrogen peroxide exist in the product; The downstream products which take CS as the active ingredient, such as CS tablet, capsule, injection, eye drops, are not able to be used by people who has an allergic reaction to protein, solvent and hydrogen peroxide; one of the reasons of why no CS oral liquid is produced worldwide is many people has allergic reaction; The water contained in the CS is hard to reach ≦1%, that is in a constant volume (as in a capsule) and weight (as in a tablet and capsule) the CS content is reduced which leads to long treatment period an unobvious treatment benefits; People's reservation on the benefit of the CS products cause difficulties in expending the sale volume of the whole industry and the consumption of CS is dwelling around 5000 tons; (8) The using of solvent and pancreatin severely pollutes the environment and is rejected by Muslim country; to build CS factories is not permitted in many countries, which handicaps the integration of the resource, recycling the waste worldwide and expending the production capacity to ten thousand tons; to get the benefit out of large quantity with good quality and low price is hard to realize; people worldwide is not able to be benefited and treated with CS at a low price; besides, over 80% of the products produced in the solvent extraction process contains hydrogen peroxide; taking the beef brisket as an example, for each ton of CS product 300-400 kilogram of hydrogen peroxide is consumed; the hydrogen peroxide is harmful for the consumers.

Chinese patent application 201210576946.3 “Organic-solvent-free extraction process of chondroitin sulfate” provides an organic-solvent-free extraction method comprising the following steps: ripening animal cartilage meal; adding the protease; enzymolyzing with enzyme; rising the temperature to kill the enzyme; cooling down the liquid of inactivated enzyme to the environment temperature; filtering the liquid; adjusting the PH of the filtrate to 5-8; passing the cation-exchange resin; collecting the effluent A; eluting the effluent A with purified water; collecting the eluent B; mixing the effluent A with the eluent B; spray drying the mixture after ultrafitration concentration. Killing the enzyme is required in the method, which complexes the producing procedure and increases the investment, beside the lack of extraction step causes the generation of impurities and pollutants during the production. The method has the disadvantages of huge investment, long producing cycle, high energy consumption and severe pollution.

### SUMMARY OF THE PRESENT INVENTION

An object of the present invention is to provide a chondroitin sulfate preparing method and the device thereof to find another way to extract CS besides the solvent method. From the materials input to the output of the final products, the whole production procedure is able to be carried out automatically. The present invention overcomes the disadvantages of huge investment, long production cycle, high energy consumption, severe pollution, high cost and side effects (for people allergic to protein, organic solvent and hydrogen peroxide) of the conventional CS extraction method, which expands the product types (the CS oral liquid is not able to be produced by conventional method), market volume and application field. Compared to the conventional method, the present invention saves over 80% of the investment in capital in production of the same scale. The larger the production scale is the less the relative investment is. The maximum production capacity is able to be over ten thousand tons which is impossible by using solvent method. The production is able to be carried out automatically and continuously. The quality of the products is able to be controlled at will. The CS content is from 60-105% (measured by CPC). The present invention is able to fulfill or exceed the current product quality standard. The present invention produces no pollution, has zero-discharge and environmentally friendly.

The technical solution of the present invention is as follow:

A chondroitin sulfate preparation method, comprising: liquefying, extracting of enzymolysis degradation, filtering, separating and after-treatment, wherein operation steps are as follow:

(1) liquefying: liquefying materials after steaming under pressure to change the materials into liquid;

wherein the materials in the step (1) are frozen cartilage meal or frozen cartilage cement; the frozen cartilage meal is smashed or minced frozen cartilage meal which is cold stored in blocks; the frozen cartilage meal is fresh, no meat attached, no oil and no spoilage;

the steaming temperature in the step (1) is 100-120° C.;

(2) extracting of enzymolysis degradation: cooling down a cartilage fluid liquidated in the step (1) to 25-35° C.; adding an alkali for alkaline hydrolysis; adding an enzymolysis enzyme and an degradation enzyme for enzymolysis and degradation until the cartilage fluid disassociating into layers, that is the CS and protein substance naturally separate to produce the mixed fluid;

wherein the specified operation steps in the step (2) are as follows: cooling down the liquidated cartilage fluid produced in the step (1) to 25-35° C.; adding a NaOH of 0.8-1.2% of the total liquid volume for alkaline hydrolysis and extracting; adding the enzymolysis enzymes of 3-9% and the degradation enzymes of a same quantity for enzymolysis and degradation respectively until cartilage fluid disassociating into layers, that is a natural-separation between CS and protein; generating the mixed fluid;

(3) filtering: continuously filtering a mixed fluid produced in the step (2) by a filter device; producing a filtrate and cartilage residues; keeping a clarity of the filtrate within 0.001-0.10;

wherein a vacuum cycle filter is selected as the filter device; the cycle vacuum filter continuously filter the mixed fluid until the filtrate is clean, transparent, not turbid and no impurities;

(4) separating: separating a CS (chondroitin sulfate) with a small molecular protein substance such as amino acids through physical method; producing a permeate and a concentrated liquid; drying the bone residue produced in the step (3) to produce the animal cartilage meal which is able to be used as feed and realizes waste recycling; no discharge or separated treatment is needed, which is environmentally friendly with little pollution;

wherein the physical method for separation is a molecular sieve; big molecules with a molecular mass over 3000 separated by the molecular sieve is the concentrated liquid; small molecules with a molecular mass under 3000 is the permeate;

(5) after-treatment: concentrating and drying the permeate produced in the step (4) to produce the animal protein powder; dehydrating the concentrated liquid produced in the step (4) to produce a chondroitin sulfate.

The products is formed and packed in the barrel, seal the barrel and stick a mark.

To finish the step (1) needs 1-3 hours; to finish the step (2) needs 6-8 hours; to finish the step (3) needs around 2 hours; to finish the step (4) needs 2-3 hours; to finish the step (5) needs around 3 hours; the whole process costs less than 20 hours and is able to be carried out automatically or semi-automatically continuously.

The device adopted in the step (1) and the step (2) is made of stainless steel, polypropylene or Teflon. As for the cost and service life, the Teflon out beat the other two materials in erosion-proof, high acid base-proof, long service life, economic, no franklinic reaction; the steaming device preferably adopts the Teflon kettle; the continuous filtration device in the step (3) preferably adopts the cycling vacuum filter; the drying device in the step (4) and the step (5) preferably adopts the Teflon drying device. The device is connected with Teflon pipes or flange connections which enable the continuous automatic and semi-automatic production to produce the products. The whole system is highly automatic.

The device for the chondroitin sulfate preparation method comprises the reaction kettle which is preferably the Teflon kettle, wherein the reaction kettle is connected to the cycling vacuum filter, the filtrate storage tank and the molecular sieve in sequence by pipeline, wherein the molecular sieve is connected to the protein fluid storage tank and the CS solution storage tank respectively. First boiling the materials in the reaction kettle, cooling down, alkaline hydrolysis, enzymolysis and degradation the materials to finish the step (1) and the step (2); then filtering the fluid by the cycling vacuum filter to finish the step (3); pumping the filtrate into the filtrate storage tank; pumping the materials from the filtrate storage tank into the molecular sieve to separate the materials and finish the step (4); pumping the separated products into the protein fluid storage tank and the CS solution storage tank respectively to finish the after-treatment of the step (5).

Furthermore, pumps are set between the cycling vacuum filter and the filtrate storage tank and between the filtrate storage tank and the molecular sieve. A cycling pump is set between the molecular sieve and the protein fluid storage tank and between the molecular sieve and the CS solution storage tank. The outlet of the cycling pump is connected with the inlet of the molecular sieve, which enables multiple separations and improves the separation result.

Furthermore, a height difference exists between the reaction kettle and the cycling vacuum filter, which enables the materials flow naturally and reduces the production cost.

Furthermore, the protein fluid storage tank is connected to the dewatering device, or the protein fluid storage tank is connected to the dewatering device and the drying device in sequence to produce the animal protein powder.

Furthermore, the CS solution storage tank is connected to the dewatering device, or the CS solution storage tank is connected to the dewatering device and the drying device in sequence to produce the chondroitin sulfate.

The benefits of the present invention are as below:

(1) producing the CS products without the solvents;

(2) the whole producing procedure costs less than 20 hours, which is carried out automatically or semi-automatically to continuously produce the final products;

(3) small quantity of acid and base are used in the production, which accounts for 15%-30% of the products weight; wherein the investment is low; the producing capacity is high; the economic benefits is big;

(4) the waste liquid and waste water generated in the extraction and purification process are able to be treated and recycled with simple physical treatment; wherein no discharge or separated treatment are needed, which has low pollution and is environmentally friendly;

(5) the odorous air is able to be treated with air purification device to meet the required standard before being discharged, which is safe and environmentally friendly;

(6) the whole producing procedure has high automation degree, wherein a self-production capacity over 100 tons needs less than 15 people, which reduces the production cost;

(7) the quality of the products fulfills or exceeds the requirements of the current American USP35 (Ubiquitin Specific Peptidase 35), western Europe EP7.0 (Light magnesium oxide) and Chinese Pharmacopoeia; the products is high quality;

(8) compared with the solvent method, the cost of the present invention reduced around 40%-70%; the production cost is reduced and the economic benefits is improved;

(9) the down stream products are further developed and expanded by adopting the products produced with present invention as the active ingredient, such as CS sodium salt, calcium salt, potassium salt, zinc salt oral liquid and shark CS oral liquid and compound oral liquid; the perspective of the products produced with the present method is promising;

(10) the production capacity is over ten thousand tons, which is unprecedented and out beat the solvent method.

The present invention is further illustrated with the drawings and embodiments as below.

### BRIEF DESCRIPTION OF THE DRAWINGS

FIG. 1 is a process flow diagram of an embodiment of the present invention;

FIG. 2 is a block diagram illustrates device connection of the embodiment of the present invention.

### DETAILED DESCRIPTION OF THE PREFERRED EMBODIMENT

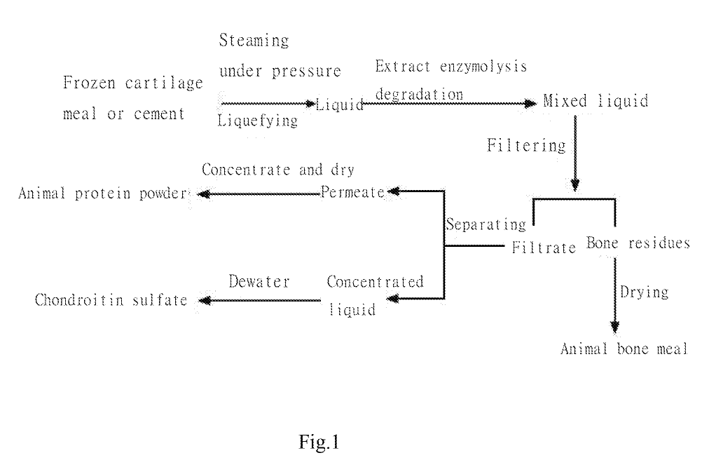

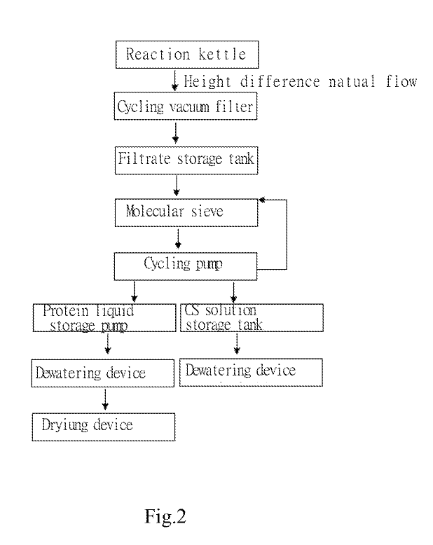

The embodiments are for illustrating and explaining the present invention. The present invention is not limited by the embodiments. Referring to FIG. 1 and FIG. 2 of the drawings, according to preferred embodiments of the present invention is illustrated as follow.

The percentage used in the present invention is weight percentage except noted otherwise.

### Embodiment 1

As illustrated in the FIG. 1, the specific operation steps of the chondroitin sulfate preparation method are as follow:

(1) liquefying: putting the materials in the reaction kettle; steaming the materials at 100-120° C. to unfreeze the materials; liquefying materials after steaming under pressure to change the materials into liquid; the whole process needs 1-3 hours;

wherein the materials are fresh frozen cartilage meal or frozen cartilage cement, wherein the fresh frozen cartilage meal refers to the cartilage taken from the slaughtered animals (such as the beef, pig, sheep, chick, duck, shark). After being treated until no meat attached, no oil and no spoilage, the cartilage is smashed or minced and is cold stored in blocks of a certain weight (such as 10 kg-20 kg/block); The cartilage meal is stored in square cases for frozen refrigerated storage (−5-−20° C.) to produce cartilage meal blocks.

(2) extracting of enzymolysis degradation: cooling down a cartilage fluid liquidated in the step (1) to 25-35° C.; adding a NaOH of 0.8-1.2% of the total liquid volume for alkaline hydrolysis and extracting for 3 hours; adding the A enzyme which is enzymolysis enzymes (exonucleases) of 3-9% and the B enzymes which is degradation enzymes (endonuclease) of a same quantity for enzymolysis and degradation until the cartilage fluid disassociating into layers, that is a natural-separation between CS and protein; generating the mixed fluid; the whole process needs 6-8 hours. The A enzyme which is enzymolysis and the B enzymes which is degradation enzymes adopt the conventional extracting enzymes which don't affect the result of the present invention;

(3) filtering: continuously filtering a mixed fluid produced in the step (2) by a cycling vacuum filter; filtering out the undegraded big molecular protein and the cartilage residues; generating a filtrate and cartilage residues; keeping a clarity of the filtrate within 0.001-0.10; the cycle vacuum filter continuously filter the mixed fluid until the filtrate is clean, transparent, not turbid and no impurities; the whole process needs 2 hours;

(4) separating: separating a CS (chondroitin sulfate) with a small molecular protein substance such as amino acids from the filtrate generated in the step (3) through physical method; producing a permeate and a concentrated liquid; wherein the permeate is amino acids small molecular protein-contained liquid; the concentrated liquid is CS-contained liquid; the whole process needs around 2-3 hours; drying the bone residue produced in the step (3) to produce the animal cartilage meal which is able to be used as feed and realizes waste recycling; no discharge or separated treatment is needed, which is environmentally friendly with little pollution; wherein the physical method for separation is a molecular sieve; big molecules with a molecular mass over 3000 separated by the molecular sieve is the concentrated liquid; small molecules with a molecular mass under 3000 is the permeate;

(5) after-treatment: concentrating and drying the permeate produced in the step (4) to produce the animal cartilage meal; dehydrating the concentrated liquid generated in the step (4) to produce a chondroitin sulfate. The whole process need around 3 hours.

The products is formed and packed in the barrel, seal the barrel and stick a mark

### Embodiment 2

The device for chondroitin sulfate preparation method, as recited in the embodiment 1, comprising a reaction kettle, wherein a Teflon reaction kettle is selected; the reaction kettle is connected to a vacuum circulation filter, a filtrate storage tank and a molecular sieve by pipeline in sequence, wherein the molecular sieve is connected to a protein fluid storage tank and a CS solution storage tank respectively. First boiling the materials in the reaction kettle, cooling down, alkaline hydrolysis, enzymolysis and degradation the materials to finish the step (1) and the step (2); then filtering the fluid by the cycling vacuum filter to finish the step (3); pumping the filtrate into the filtrate storage tank; pumping the materials from the filtrate storage tank into the molecular sieve to separate the materials and finish the step (4); pumping the separated products into the protein fluid storage tank and the CS solution storage tank respectively to finish the after-treatment of the step (5); pumps are set between the cycling vacuum filter and the filtrate storage tank and between the filtrate storage tank and the molecular sieve; a cycling pump is set between the molecular sieve and the protein fluid storage tank and between the molecular sieve and the CS solution storage tank; the outlet of the cycling pump is connected with the inlet of the molecular sieve, which enables multiple separations and improves the separation result; a height difference exists between the reaction kettle and the cycling vacuum filter, which enables the materials flow naturally and reduces the production cost; the protein fluid storage tank is connected to the dewatering device and drying device in sequence to produce the animal protein powder; the CS solution storage tank is connected to the dewatering device to produce the chondroitin sulfate.

For example, taking the beef bones as the materials to produce the CS product further explains the present invention as follow:

1. Taking 600 kg beef nasal bone meal to put into a 1000 liter reaction kettle; adding 300 kg water; heating to 110° C.; steaming for 90 minutes at a constant temperature; cooling down the materials;

2. lowering the temperature to below 35° C.; alkaline hydrolyzing the materials for 3 hours; adding A enzyme (exonucleases) for enzymolysis reaction for 2 hours; adding B enzyme (exdonuclease) for degradation reaction for 2 hours; reacting in a pipe reactor;

3. rising the temperature to 85° C. after finishing the degradation reaction; standing for 30 minutes; cooling down the materials; carrying out the reaction in the reaction kettle;

4. lowering the temperature to below 70° C.; pumping the cooled mixed liquid to the vacuum filter system to generate the filtrate and bone residues by vacuum filtration;

5. separating the filtrate; drying the bone residues by the fire or the sun to produce the animal bone meal, which is able to be used as the feed;

6. separating the filtrate with a molecular sieve; separating the big molecular CS (molecular mass ≧3000) from the small molecular amino acids protein (molecular mass <3000) to generate the CS concentrated liquid and the permeate;

7. concentrating the separated CS concentrated liquid repeatedly until the mass concentration of the substrate ≧30%; drying the liquid to produce 45 kg CS products; the yield is 7.5%;

8. concentrating and drying the separated permeate to produce 90 kg animal protein meal; the yield is 15%.

Furthermore, the procedures is able to be adopted for producing CS products with other animal cartilage as the materials such as pig, sheep, chick, duck cartilage.

The comparison of the product produced by the present invention (solvent-free method) and the solvent method is illustrated in the following chart:

(the product quality is compared based on the American USP35 (Ubiquitin Specific Peptidase 35))

The source of the materials: beef nasal cartilage (frozen); quantity: 100 kg

| The method | | | | | | | |
|---|---|---|---|---|---|---|---|
| and the | | | | Optical | | | Solvent |
| quality standard | CPC | Water | Clarity | rotation | Protein | PH | residues |
| American | 90.0~105.0% | ≦10.0% | ≦0.35% | −20.0~−30.8 | ≦6.0% | 5.5~7.5 | ≦5000 ppm |
| USP35 standard | | | | | | | (customer |
| | | | | | | | requirements) |
| CS products by | 90.0~105.0% | ≦10.0% | ≦0.35% | −20.0~−30.0 | ≦6.0% | 5.5~7.5 | ≦5000 ppm |
| conventional | | | | | | | |
| solvent method | | | | | | | |
| CS products by | 90.0~105.0% | ≦3.0% | ≦0.3~0.001% | −20.0~−30.0 | ≦1.0% | 5.5~7.5 | No |
| the present | | | | | | | |
| invention of | | | | | | | |
| solvent-free method | | | | | | | |

| The method | | | | | | |
|---|---|---|---|---|---|---|
| and the | | | Hydrogen | | | Packing |
| quality standard | Chloride | Sulfate | peroxide | Apperance | Yield | density |
| American | ≦0.50% | ≦0.24% | | White | | ≧0.48 g/cc |
| USP35 standard | | | | or | | |
| | | | | almost | | |
| | | | | white | | |
| CS products by | ≦0.54% | ≦0.24% | Yes | Fulfil | ≦6% | Fulfil |
| conventional | | | | the | | |
| solvent method | | | | requirement | | |
| CS products by | ≦0.10% | ≦0.10% | No | White | ≧6.5% | Fulfil |
| the present | | | | | | |
| invention of | | | | | | |
| solvent-free method | | | | | | |

The materials adopts by the present invention is commonly used in production in the field, which is able to be obtained in the market and doesn't affect the production result; the device adopted in the present invention is the regular device used in the production in the field; the operation and parameter setting of the device follows the regular rules; the present invention has no special requirement for the device.

1: A chondroitin sulfate preparation method, comprising steps of: liquefying, extracting enzymolysis degradation, filtering, separating and providing after-treatment, wherein specifically:
(1) liquefying: liquefying materials after steaming under a pressure to change the materials into liquid;
(2) extracting enzymolysis degradation: cooling down a cartilage fluid liquidated in the step (1); adding an alkali for alkaline hydrolysis;
adding an enzymolysis enzyme and a degradation enzyme for enzymolysis and degradation until the cartilage fluid disassociates into layers;
(3) filtering: continuously filtering a mixed fluid produced in the step (2) by a filter device; producing a filtrate and cartilage residues; keeping a clarity of the filtrate within 0.001-0.10;
(4) separating: separating a CS (chondroitin sulfate) with a small molecular protein through physical method; generating a permeate and a concentrated liquid, wherein the permeate is an amino acid small molecule protein-contained liquid; the concentrated liquid is a CS-contained liquid; drying the cartilage residues produced in the step (3) to produce an animal bone meal; and
(5) providing after-treatment: concentrating and drying the permeate produced in the step (4) to produce the animal protein powder; dehydrating the concentrated liquid produced in the step (4) to produce the chondroitin sulfate.

2: The chondroitin sulfate preparation method, as recited in claim 1, wherein the materials in the step (1) are a frozen cartilage meal or a frozen cartilage cement.

3: The chondroitin sulfate preparation method, as recited in claim 2, wherein the frozen cartilage meal is a smashed or minced frozen cartilage meal which is cold stored in blocks.

4: The chondroitin sulfate preparation method, as recited in claim 1, wherein a steaming temperature in the step (1) is 100-120° C.

5: The chondroitin sulfate preparation method, as recited in claim 1, wherein specified operation steps in the step (2) are as follows: cooling down the liquidated cartilage fluid produced in the step (1) to 25-35° C.; adding a NaOH of 0.8-1.2% of a total liquid volume for alkaline hydrolysis and extracting; adding the enzymolysis enzymes of 3-9% and the degradation enzymes of a same quantity for enzymolysis and degradation respectively until the cartilage fluid disassociates into the layers, which is a natural-separation between CS and protein; generating the mixed fluid.

6: The chondroitin sulfate preparation method, as recited in claim 1, wherein the physical method for separation in the step (4) is a molecular sieve; big molecules with a molecular mass over 3000 separated by the molecular sieve is the concentrated liquid; small molecules with a molecular mass under 3000 is the permeate.

7-10: (canceled)

11: The device for chondroitin sulfate preparation method, as recited in claim 1, comprising a reaction kettle, wherein a Teflon reaction kettle is selected; the reaction kettle is connected to a vacuum circulation filter, a filtrate storage tank and a molecular sieve by pipelines in sequence, wherein the molecular sieve is connected to a protein fluid storage tank and a CS solution storage tank respectively.

12: The device for chondroitin sulfate preparation method, as recited in claim 2, comprising a reaction kettle, wherein a Teflon reaction kettle is selected; the reaction kettle is connected to a vacuum circulation filter, a filtrate storage tank and a molecular sieve by pipelines in sequence, wherein the molecular sieve is connected to a protein fluid storage tank and a CS solution storage tank respectively.

13: The device for chondroitin sulfate preparation method, as recited in claim 5, comprising a reaction kettle, wherein a Teflon reaction kettle is selected; the reaction kettle is connected to a vacuum circulation filter, a filtrate storage tank and a molecular sieve by pipelines in sequence, wherein the molecular sieve is connected to a protein fluid storage tank and a CS solution storage tank respectively.

14: The device for chondroitin sulfate preparation method, as recited in claim 6, comprising a reaction kettle, wherein a Teflon reaction kettle is selected; the reaction kettle is connected to a vacuum circulation filter, a filtrate storage tank and a molecular sieve by pipelines in sequence, wherein the molecular sieve is connected to a protein fluid storage tank and a CS solution storage tank respectively.

15: The device, as recited in claim 11, wherein pumps are set between the vacuum circulation filter and the filtrate storage tank and between the filtrate storage tank and the molecular sieve respectively; a circular pump is set between the molecular sieve and the CS solution tank; an outlet of the circular pump is connected to an inlet of the molecular sieve.

16: The device, as recited in claim 12, wherein pumps are set between the vacuum circulation filter and the filtrate storage tank and between the filtrate storage tank and the molecular sieve respectively; a circular pump is set between the molecular sieve and the CS solution tank; an outlet of the circular pump is connected to an inlet of the molecular sieve.

17: The device, as recited in claim 13, wherein pumps are set between the vacuum circulation filter and the filtrate storage tank and between the filtrate storage tank and the molecular sieve respectively; a circular pump is set between the molecular sieve and the CS solution tank; an outlet of the circular pump is connected to an inlet of the molecular sieve.

18: The device, as recited in claim 11, wherein a height difference exists between the reaction kettle and the vacuum circulation filter.

19: The device, as recited in claim 11, wherein the protein fluid storage tank is connected to a dewatering device, or the protein fluid storage tank is connected to the dewatering device and a drying device in sequence; the CS solution storage tank is connected to a dewatering device, or the CS solution storage tank is connected to the dewatering and a drying device in sequence.

20: The device, as recited in claim 12, wherein the protein fluid storage tank is connected to a dewatering device, or the protein fluid storage tank is connected to the dewatering device and a drying device in sequence; the CS solution storage tank is connected to a dewatering device, or the CS solution storage tank is connected to the dewatering and a drying device in sequence.

21: The device, as recited in claim 13, wherein the protein fluid storage tank is connected to a dewatering device, or the protein fluid storage tank is connected to the dewatering device and a drying device in sequence; the CS solution storage tank is connected to a dewatering device, or the CS solution storage tank is connected to the dewatering and a drying device in sequence.

22: The device, as recited in claim 14, wherein the protein fluid storage tank is connected to a dewatering device, or the protein fluid storage tank is connected to the dewatering device and a drying device in sequence; the CS solution storage tank is connected to a dewatering device, or the CS solution storage tank is connected to the dewatering and a drying device in sequence.

23: The device, as recited in claim 13, wherein the protein fluid storage tank is connected to a dewatering device, or the protein fluid storage tank is connected to the dewatering device and a drying device in sequence; the CS solution storage tank is connected to a dewatering device, or the CS solution storage tank is connected to the dewatering and a drying device in sequence.

24: The device, as recited in claim 14, wherein the protein fluid storage tank is connected to a dewatering device, or the protein fluid storage tank is connected to the dewatering device and a drying device in sequence; the CS solution storage tank is connected to a dewatering device, or the CS solution storage tank is connected to the dewatering and a drying device in sequence.
